(19) United States
(12) Patent Application Publication
(10) Pub. No.: US 2009/0253108 A1
(43) Pub. Date: Oct. 8, 2009

(54) METHOD FOR TESTING EXECUTIVE FUNCTIONING

(76) Inventor: Peter Daly, Cape Elizabeth, ME (US)

Correspondence Address: PATRICK R. SCANLON;PRETI FLAHERTY BELIVEAU & PACHIOS LLP, ONE CITY CENTER, PORTLAND, ME, 04112-9546, US

(21) Appl. No.: 12/098,032

(22) Filed: Apr. 4, 2008

(51) Int. Cl. G09B 19/00

(52) U.S. Cl. 434/236; 434/362

(57) ABSTRACT

A method testing executive functioning of a subject includes determining the subject's performance ceiling for performing at least one task and then measuring the subject's efficiency at performing the task at a difficulty level just below the performance ceiling, first without additional distractions and then with additional distractions. The subject's executive functioning is then determined by comparing the subject's efficiency without additional distractions to the subject's efficiency with additional distractions. In one embodiment, the method can be implemented in a game-like format.

### BACKGROUND OF THE INVENTION

This invention relates generally to testing certain high level cognitive processes, commonly referred to as executive functions, and more particularly to testing verbal working memory, nonverbal working memory, and interference control.

Deficits in executive functioning are associated with a number of developmental disabilities, notably Attention-Deficit Hyperactivity Disorder (ADHD). ADHD is a developmental disorder characterized by a persistent pattern of inattention and/or hyperactivity, as well as forgetfulness, poor impulse control or impulsivity, and distractibility. Currently, no objective physical test exists to diagnose developmental disorders such as ADHD. A formal diagnosis of ADHD is typically made by a clinician based on a set number of criteria.

Psychological tests are sensitive to deficits in executive functioning and some are sensitive to performance changes associated with stimulant medication. However, studies show that none of the widely used psychological tests have sufficient discriminative power to be clinically useful in isolation. Because of this, psychological tests have not proven to be cost effective lab tests and are not widely used by professionals when making pharmacological decisions regarding treatment for developmental disorders.

A large body of empirical evidence supports the conclusion that a group of tests, referred to as Continuous Performance Tests (CPTs), is the best of the currently available tests for evaluating the deficits associated with ADHD. CPTs are computer administered. Generally, the subject being tested watches a screen and letters are flashed at varying time intervals. The subject is instructed to respond (e.g., push a button) when a certain letter or sequence appears. Scores are derived based on the number of target stimuli missed (commission errors) and the number of responses following incorrect stimuli (commission errors). Errors of commission are associated with impulsivity, and errors of omission are associated with inattention. There are many different designs based on this paradigm that vary the type of stimulus presented, interval length, length of test, rules that define target stimuli, and instructions given to the subject. The four most widely used CPTs are the Conners' CPTII, the Test of Variable Attention (TOVA), the Intermediate Visual and Auditory Continuous Performance Test (IVA), and the Gordon Diagnostic System (GDS). U.S. Pat. No. 4,730,253 issued to Michael Gordon on Mar. 8, 1988 describes to the GDS.

CPTs generally have a number of design features that are believed to be beneficial in evaluating the deficits associated with ADHD. These design features include: 1) direct measurement of impulsivity and inattention, which are two core symptoms of the disorder; 2) the use of computer administration, which controls for examiner interaction (variations due to different examiners); and 3) measurement of efficiency rather than capacity (e.g., capacity for reasoning, amount of knowledge, etc.). Nevertheless, CPTs have significant limitations. For instance, one prominent criticism of CPTs is that they are actually measuring task persistence, not inattention. This is because the typical CPT is elemental and not interactive; it is not stimulating for the subject and thus can be tedious.

### SUMMARY OF THE INVENTION

The above-mentioned need is met by the present invention, which provides, in one aspect, a method for testing executive functioning of a subject that includes determining the subject's performance ceiling for performing at least one task and then measuring the subject's efficiency at performing the task at a difficulty level just below the performance ceiling, first without additional distractions and then with additional distractions. The method then determines the subject's executive functioning by comparing the subject's efficiency without additional distractions to the subject's efficiency with additional distractions.

In another aspect, the present invention provides a computer-readable medium containing instructions for controlling a computer system to perform the method for testing executive functioning discussed above.

### DESCRIPTION OF THE DRAWINGS

FIG. 1 is a block diagram of a computer system for implementing a software program for measuring executive functioning.

FIG. 2 shows a flow chart depicting one embodiment of a method for measuring executive functioning.

### DETAILED DESCRIPTION OF THE INVENTION

The present invention relates generally to testing executive functioning. Executive functions refer to a cluster of high-level cognitive processes that control, manage, and allocate other mental resources to yield goal directed behavior. Stated differently, executive functions guide thought and behavior in accordance with internally generated goals. The executive functions include behavior inhibition, attention regulation, verbal working memory, nonverbal working memory, metacognition, and affect regulation. Developmentally, behavioral inhibition emerges first (typically at 5-12 months) and underpins the development of the other executive functions. There are three dimensions to behavioral inhibition: inhibition (of a prepotent response), interruption (of an ongoing response), and interference control. Interference control pertains to the ability to manage distractions that could interfere with the work of other executive functions and thereby disrupt goal directed behavior. A developmental deficiency in behavioral inhibition is believed to underlie Attention-Deficit Hyperactivity Disorder (ADHD).

In one embodiment, the present invention provides a method for objectively testing executive functioning in human subjects. The method is particularly useful for testing children (e.g., ages 5-13) but is not limited to any particular age group. The method generally includes: 1) determining a subject's “performance ceiling” for completing one or more tasks; 2) measuring the subject's efficiency at performing the tasks at a difficulty level just below his or her performance ceiling, both with distractions and without distractions; and 3) comparing the subject's efficiency at performing the tasks without distractions to the efficiency with distractions. The difference in efficiency in performing the tasks with and without distractions is a measure of the subject's distractibility. That is, a significant decrease in efficiency due to distractions is indicative of a deficiency in the subject's interference control. By providing an objective test of executive functioning, the method will aid clinicians in diagnosing developmental disabilities, such as ADHD, as well as in making decisions regarding treatment of such disorders. The method can also be used to evaluate the efficacy of interventions in a timely manner.

The method can be implemented as an interactive computer program in which the testing procedure is presented in a game-like format. For instance, the computer program can present a game in which the subject will be asked to accomplish a “mission,” which will typically be time dependent in nature. As part of the game, the subject will be put through a number of tasks (which are designed to measure verbal working memory, nonverbal working memory, and interference control). Such a game can include a guide that assists the subject with the tasks and an antagonist that will attempt to hinder the subject and prevent success. This interactive, game-like aspect will tend to engage and stimulate the subject, and therefore make the testing procedure less tedious than standard testing procedures. The game-like format provides continuous external reinforcement such that the method controls for persistence.

Such a computer program can be implemented on any suitable computer system. As used herein, the term “computing system” refers to any type of device that is capable of processing data based on a list of instructions. This includes, but is not limited to, server computers, desktop computers, laptops, personal digital assistants (PDAs), wireless e-mail devices, video game systems and the like.

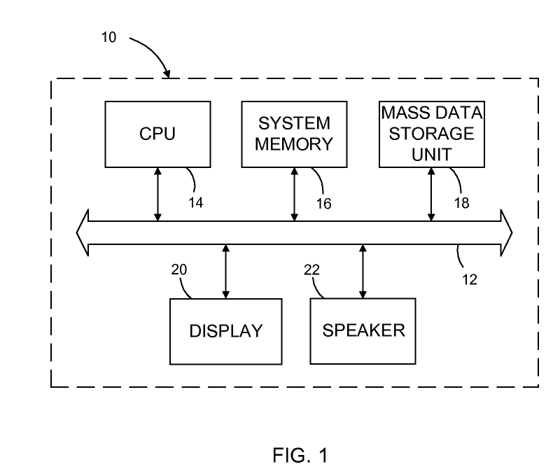

FIG. 1 depicts one possible embodiment of a computer system 10 that can be used to implement the above-mentioned computer program. In general, the computer system 10 includes a system bus 12 for communicating information and a central processing unit (CPU) 14 for processing information and instructions. The CPU 14 is coupled with the bus 12 and may comprise one or more microprocessors or any other type of processor. The computer system 10 also includes a system memory 16 and a mass data storage unit 18 coupled with the bus 12. The system memory 16 generally includes computer readable media for storing information and instructions for the CPU 14. This can be in the form of volatile memory such as random access memory (RAM) and/or non-volatile memory such as read only memory (ROM). The mass data storage unit 18 may include one or more types of removable and/or non-removable computer readable media. These include, but are not limited to, a hard disk, a floppy disk, an optical disk such as a CD-ROM, CD-R, CD-RW, DVD-ROM, DVD-RAM or other optical media, and flash memory. A display 20 for displaying information to a user and a speaker 22 for emitting sounds are also coupled to the bus 12.

In one possible implementation, the computer program resides within one or more computer readable media of the computer system 10. For instance, the computer program can be downloaded onto the system memory 16 and/or the mass data storage unit 18 of the computer system 10. Alternatively, the computer program could be accessed from a removable computer readable medium (such as a floppy disk, CD-ROM or the like) inserted into the appropriate drive of the computer system 10. In another possible implementation, the computer program could reside on a remote computer readable medium and be accessed by the computer system 10 via the Internet or other computer network. As used herein, the term “computer readable medium” refers generally to any medium (including both volatile and non-volatile media, as well as removable and non-removable media) from which stored data can be read by a computer or similar device. Computer readable media include, but are not limited to, hard disks, floppy disks, magnetic cassettes, flash memory cards, flash drives, optical media such as a CD-ROM, CD-R, CD-RW, DVD-ROM, DVD-RAM and the like, random access memories (RAMs), read only memories (ROMs), and other integrated circuit memory devices. While one exemplary computer system has been described for purposes of illustration, it should be noted that the present invention is not limited to implementation on this particular system. One skilled in the art will recognize that many other systems are possible.

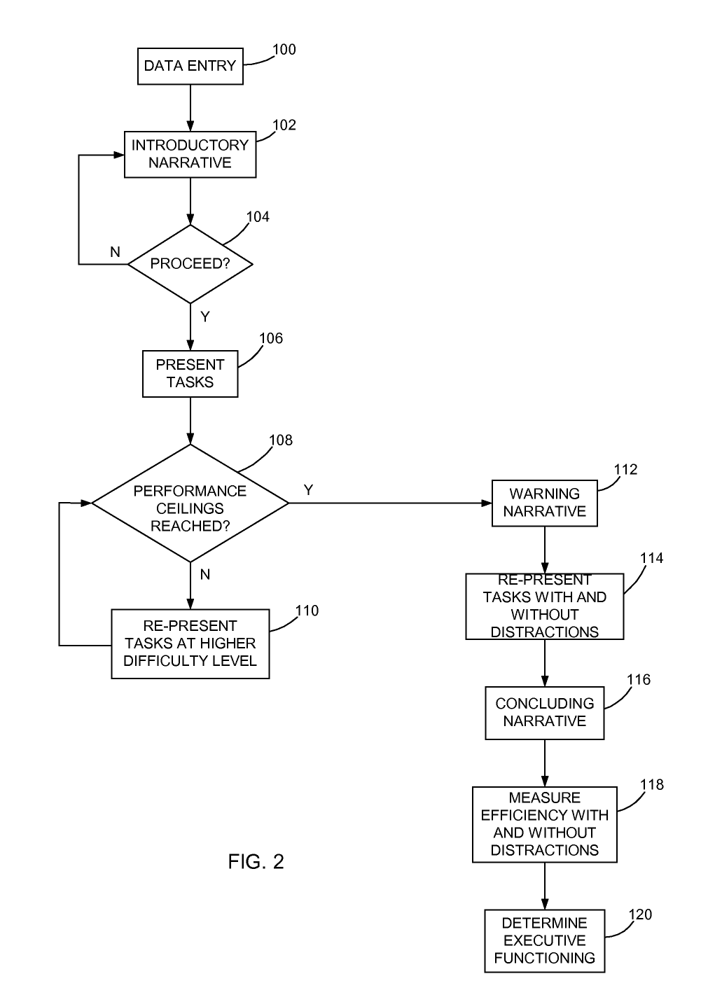

Referring to FIG. 2, one embodiment of a method for testing executive functioning is depicted. In this embodiment, the method is deployed as an interactive, game-like computer program implemented on a computer system. The method begins at block 100 wherein the subject being tested or a person administering the testing enters data relevant to the subject. These data can include the subject's name, date of birth, date of the test, and location of the test. Other information regarding the subject, such as grade level (for students), ethnicity, sex and handedness, can also be collected.

Next, at block 102, the computer program causes an introductory narrative to be presented (e.g., displayed by the computer system). The introductory narrative introduces the game and describes its basic instructions and goals. For instance, where the computer program involves a game in which the subject is assigned a mission, the narrative will describe the nature and purpose of the mission and will indicate whether there will be a guide to assist the subject and/or an antagonist presenting obstacles. The narrative can be presented visually, auditorily, or both visually and auditorily. After the narrative is completed, the subject will be given an opportunity to choose between proceeding with the game or seeing/hearing the narrative again. Typically, the computer program will display two icons, one for proceeding with the game and one for repeating the narrative. Thus, as shown at block 104, if the subject does not elect to proceed (by selecting the second icon), the introductory narrative will be repeated. If the subject does elect to proceed (by selecting the first icon), the method will proceed to block 106.

At block 106, the subject is presented with a series of tasks that he or she is asked to complete. Generally, the subject will attempt to complete the tasks by entering input regarding the tasks into the computer system. Although only one task could be presented, the method will typically employ multiple tasks. The subject will be required to correctly perform each task before being allowed to move to the next task. The present invention is not limited to a particular number of tasks, but typically a sufficient number, such as 3 or 4, of tasks will be used in order to obtain an accurate indication of the subject's ability level. The tasks are interactive tasks that place demands on verbal working memory and nonverbal working memory. Generally, some sort of a scene is displayed, and the subject is required to provide input based on the scene. For example, one possible task could involve a scene showing a number of pedestals with non-symmetrical but roughly equidistant placement. The guide would be shown demonstrating a pattern of movements by jumping from pedestal to pedestal in a particular order. The subject would then be asked to replicate the pattern of movements by clicking on the pedestals in the order demonstrated by the guide. This task measures the subject's nonverbal working memory. The difficulty level of this task can be increased in a number of aspects, such as increasing the number of jumps, increasing the distance between pedestals, and increasing the complexity of the jumps (i.e., having jumps that crossover pedestals rather than only jumps to adjacent pedestals).

In another possible task, a scene having a series of overlapping and intertwining ropes (or vines, hoses, pipes and the like) is presented. An award or prize is shown positioned adjacent one end of one or more of the ropes. The subject is asked to obtain the award by selecting the other end of the rope that corresponds to the end having the award. If the subject selects a decoy rope (i.e., a rope that does not have an award at the other end), that rope disappears making the task less difficult. This task measures the subject's concentration and impulse control. The difficulty level of this task can be increased in a number of aspects, such as increasing the number of ropes, increasing the length of the ropes, and increasing the number of crossovers between the target and decoy ropes.

Another possible task presents a code in the form of a set of objects that vary in two aspects, such as shape and color. For example, the code could comprise objects having one of three shapes (such as circle, square and triangle) and one of three colors (such as red, green and blue). Then, another screen would be displayed that does not show the code, and the subject would be asked to reconstruct the code. If the subject forgets the code, he or she has the option of returning to the first screen showing the code. This task measures the subject's verbal working memory and distractibility. The difficulty level of this task can be increased in a number of aspects, such as increasing the number of objects in the code, increasing the number of different shapes in the code, and increasing the number of different colors in the code.

Yet another possible task could involve a scene showing a number of moving targets among multiple decoys, which are also moving. The subject will be asked to identify a number of the moving targets. The targets and the decoys vary on the same three dimensions. The correct code for the targets will be visible to the subject throughout the task. This task measures the subject's concentration and distractibility. The difficulty level of this task can be increased in a number of aspects, such as increasing the number of decoys and increasing the number of dimensions in which the targets vary from the decoys.

The subject's individual capacity or ability for performing the tasks is determined by looping the subject through these tasks at increasing difficulty levels until the subject reaches a performance ceiling for each task. The performance ceiling is reached for a task when the subject cannot complete the task. As used in this sense, “cannot complete the task” means not being able to meet the progression criteria for the task (e.g., not completing the task within a predetermined time limit and/or with less than a predetermined number of errors). Thus, after the subject has completed the series of tasks for the first time, the computer program considers at block 108 whether the subject has reached his or her performance ceiling for each task. For each task for which the subject has not reached his or her performance ceiling, the method proceeds to block 110, where such tasks are re-presented at a higher level of difficulty. The subject is asked to complete these tasks at the higher difficulty level. Only tasks for which the subject has not reached his or her performance ceiling are retested. The computer program then again considers at block 108 whether the subject has reached his or her performance ceiling for each of the remaining tasks. This loop is continued until the subject reaches his or her performance ceiling for all of the tasks.

Once the performance ceiling has been reached for all of the tasks, a warning narrative is presented, as shown at block 112. The warning narrative will inform the subject that he or she has almost succeeded in the mission, but that increased attempts to distract him or her are ahead. The purpose for providing this warning is to attach a negative valence to being distracted so that the subject will be trying his or her best. Because most people that have developmental disabilities are aware that they are easily distracted, giving them a warning will put them in a mindset to try to avoid being distracted.

Next, at block 114, the subject is asked to perform each task twice more: once without additional distractions and once again with additional distractions. In each case, the tasks are presented at a difficulty level just below the subject's performance ceiling for each task. This means that the subject is being tested in this phase at his or her individualized capacity. The distractions can be visual and/or auditory in nature. This can include stationary, moving or flashing images and various sounds including spoken words. Generally, a number of different distraction sequences will be available. The distraction sequences can be categorized into different groups depending on their characteristics. For instance, one group could comprise the least distracting distraction sequences. Visual distractions in this group would generally occur on the periphery of the scene and not in areas where the subject is operating. Also, this group would not include spoken word distractions. Another group would include intermediate distractions that occur in the subject's area of operation and typically involve more vigorous activity and/or sound but no spoken word distractions. A third group would comprise the most distracting distraction sequences. Such distractions would occur in the operational area, involve highly vigorous activity and/or sounds and involve an active attempt to shift the subject's attention using spoken words. For instance, the subject could be asked what his or her favorite color is while he or she is working on a task that involves color.

After the subject has completed the tasks with and without distractions, his or her participation is finished and a concluding narrative can be presented, at block 116. The concluding narrative will generally conclude the storyline of the game and congratulate the subject on his or her success in completing the mission.

The method also includes measuring the subject's efficiency in performing the tasks at a difficulty level just below his or her performance ceiling, as shown at block 118. Specifically, the subject's efficiency in performing the tasks without additional distractions and the efficiency in performing the tasks with additional distractions are both measured. Generally, the efficiency is the time taken to correctly complete a task. At block 120, the subject's executive functioning is determined by comparing the efficiency in performing the tasks with and without distractions. More specifically, the efficiency with distractions is subtracted from the efficiency without distractions to provide the decrease in efficiency due to the distractions. If this decrease in efficiency is more than a predetermined threshold value, then that is indicative of a deficiency in the subject's executive functioning, particularly interference control. The threshold value will generally be established empirically and can be based on a normal distribution.

While specific embodiments of the present invention have been described, it will be apparent to those skilled in the art that various modifications thereto can be made without departing from the spirit and scope of the invention as defined in the appended claims.

What is claimed is:

1. A method for testing executive functioning of a subject, the method comprising:
determining the subject's performance ceiling for performing at least one task;
measuring the subject's efficiency at performing the task at a difficulty level just below the performance ceiling and without additional distractions;
measuring the subject's efficiency at performing the task at a difficulty level just below the performance ceiling and with additional distractions; and
determining the subject's executive functioning by comparing the subject's efficiency without additional distractions to the subject's efficiency with additional distractions.

2. The method of claim 1 wherein determining the subject's performance ceiling for performing at least one task comprises having the subject repeatedly complete the task at increasing difficulty levels until the subject cannot complete the task.

3. The method of claim 1 wherein the at least one task comprises a series of tasks that place demands on verbal working memory, nonverbal working memory, and/or and interference control.

4. The method of claim 1 wherein determining the subject's executive functioning includes subtracting the subject's efficiency with additional distractions from the subject's efficiency without additional distractions to determine a decrease in efficiency due to the distractions.

5. The method of claim 4 wherein a decrease in efficiency that is greater than a predetermined threshold value is indicative of a deficiency in the subject's executive functioning.

6. The method of claim 1 wherein the additional distractions are visual and/or auditory in nature.

7. The method of claim 6 wherein the additional distractions include spoken words.

8. The method of claim 1 wherein the method is implemented as a game in which the subject is asked to complete a mission.

9. A computer-readable medium containing instructions for controlling a computer system to perform a method for testing executive functioning of a subject wherein the method comprises:
presenting a series of tasks;
receiving input regarding the tasks from the subject;
determining the subject's performance ceiling for each one of the tasks in response to the input;
re-presenting the tasks at a difficulty level that is just below the performance ceiling for each task and without additional distractions;
measuring the subject's efficiency at performing the tasks without additional distractions;
re-presenting the tasks at a difficulty level that is just below the performance ceiling for each task and with additional distractions;
measuring the subject's efficiency at performing the tasks with additional distractions; and
determining the subject's executive functioning by comparing the subject's efficiency without additional distractions to the subject's efficiency with additional distractions.

10. The computer-readable medium of claim 9 wherein determining the subject's performance ceiling for each one of the tasks comprises repeatedly presenting the tasks at increasing difficulty levels and receiving input regarding the tasks from the subject until the subject cannot complete the task.

11. The computer-readable medium of claim 9 wherein presenting a task includes displaying a scene.

12. The computer-readable medium of claim 11 wherein the additional distractions are visual images that appear on the periphery of the scene.

13. The computer-readable medium of claim 9 wherein determining the subject's executive functioning includes subtracting the subject's efficiency with additional distractions from the subject's efficiency without additional distractions to determine a decrease in efficiency due to the distractions.

14. The computer-readable medium of claim 13 wherein a decrease in efficiency that is greater than a predetermined threshold value is indicative of a deficiency in the subject's executive functioning.

15. The computer-readable medium of claim 9 wherein the additional distractions are visual and/or auditory in nature.

16. The computer-readable medium of claim 15 wherein the additional distractions include spoken words.

17. The computer-readable medium of claim 9 wherein the method is implemented as a game in which the subject is asked to complete a mission.

18. The computer-readable medium of claim 17 wherein the instructions cause the computer system to display an introductory narrative that describes the game.

19. The computer-readable medium of claim 17 wherein the instructions cause the computer system to display a warning narrative prior to the tasks being re-presented at a difficulty level that is just below the performance ceiling for each task and with additional distractions, wherein the warning narrative informs the subject that there will be increased distractions ahead.
